(19) United States
(12) Patent Application Publication
(10) Pub. No.: US 2018/0129200 A1
(43) Pub. Date: May 10, 2018

(54) Headset display device, unmanned aerial vehicle, flight system and method for controlling unmanned aerial vehicle

(71) Applicant: SHANGHAI HANG SENG ELECTRONIC TECHNOLOGY CO., LTD, Shanghai (CN)

(72) Inventors: Yu Tian, Kunshan (CN); Wenyan Jiang, Kunshan (CN)

(73) Assignee: SHANGHAI HANG SENG ELECTRONIC TECHNOLOGY CO., LTD

(21) Appl. No.: 15/857,619

(22) Filed: Dec. 29, 2017

(30) Foreign Application Priority Data
Jan. 16, 2017 (CN) 201710028729.3

(51) Int. Cl. G05D 1/00; B64C 39/02; B64D 47/08; G02B 27/22; G06F 3/01; H04N 5/33

(52) U.S. Cl. CPC G05D 1/0016; G05D 1/0038; B64C 39/024; B64D 47/08; G02B 27/225; H04N 2213/008; H04N 5/33; H04N 13/044; B64C 2201/127; B64C 2201/146; G06F 3/017

(57) ABSTRACT

A headset display device, UAV, flight system and method for controlling UAV is provided. The device includes: a collecting module configured to collecting gesture image information; a processing module configured to analytically process the gesture image information collected and translate the gesture image information collected into a control instruction for controlling the UAV; send the control instruction to the UAV; a display module configured to receive a flight image and/or flight parameters returned by the UAV and display the flight image and/or the flight parameters on a display interface; and an optical assistant module configured to perform a left-right split screen on the flight image, in such a manner that left and right eyes of a gesture operator feel seeing a fused stereoscopic image while respectively watching an image displayed on left screen and an image displayed on right screen at the same time.

### CROSS REFERENCE OF RELATED APPLICATION

The present application claims priority under 35 U.S.C. 119(a-d) to CN 201710028729.3, filed Jan. 16, 2017.

### BACKGROUND OF THE PRESENT INVENTION

### Field of Invention

The present invention relates to the field of the communication technology, and more particularly to a headset display device, an unmanned aerial vehicle (UAV), a flight system and a method for controlling the UAV.

### Description of Related Arts

In recent years, with the development of the communication technology and the reduction of the electronic cost, the unmanned aerial vehicle (UAV) becomes more and more popular, and the consumer-level UAV is gradually available for the life of ordinary consumers. The operator mainly manipulates the UAV, i.e., human-computer interaction, by remote control. Specifically, the operator sends a control instruction to the aircraft terminal through a remote control terminal, and the aircraft terminal receives the control instruction and completes corresponding control action.

At present, the remote control terminal mainly interacts with the UAV through the conventional joystick-type remote controller or through the virtual button of the touch-screen phone. However, neither of these two methods is intuitive enough to learn and operate inconveniently, which to some extent affects the popularization of UAV. At present, people try to remotely control the UAV by means of intelligent control of gesture recognition. For example, a UAV captures a gesture of a controller, recognizes the meaning of the gesture, and executes a corresponding flight operation according to the meaning of the gesture recognized.

The applicants found by research that because the distance between the UAV and the controller is remote, the clear gesture images cannot be fully captured, and with the distance increases, the complexity of the gesture recognition increases. Gesture recognition is not capable of meeting the requirements of people for high precision and timeliness of the UAV due to the errors of gesture recognition or because the gestures cannot be timely recognized due to the complicated operation time consuming.

### SUMMARY OF THE PRESENT INVENTION

In view of one or more of the problems mentioned above, the present invention provides a headset display device, an unmanned aerial vehicle (UAV), a flight system and a method for controlling the UAV.

Firstly the present invention provides a headset display device for an unmanned aerial vehicle (UAV), comprising:

a collecting module configured to collecting a gesture image information;

a processing module configured to analytically process the gesture image information collected and translate the gesture image information collected into a control instruction for controlling the UAV; and send the control instruction to the UAV;

a display module configured to receive a flight image and/or flight parameters returned by the UAV and display the flight image and/or the flight parameters on a display interface; and

an optical assistant module configured to perform a left-right split screen on the flight image, in such a manner that a left eye and a right eye of a gesture operator feel seeing a fused stereoscopic image while respectively watching an image displayed on a left screen and an image displayed on a right screen at the same time.

Secondly the present invention provides an unmanned aerial vehicle (UAV), comprising:

a receiving module configured to receive the control instruction sent by the headset display device as recited in claim 1 for controlling the UAV;

a converting module configured to convert the control instruction received into a flight action instruction;

an executing module configured to execute corresponding flight actions based on the flight action instruction;

a collecting module configured to collect data information during flight; and

a transmitting module configured to send the data information collected to the headset display device.

Thirdly, the present invention provides a flight system, comprising: headset display device as recited in claim 1 and an unmanned aerial vehicle (UAV).

Fourthly, the present invention provides a An unmanned aerial vehicle (UAV) controlling method for a side with a headset display device, comprising steps of:

collecting gesture image information of an operator;

analytically processing the gesture image information collected and translating the gesture image information collected into a control instruction for controlling the UAV;

sending the control instruction to the UAV.

Fifthly, the present invention provides an unmanned aerial vehicle (UAV) controlling method for a side with a headset display device, comprising steps of:

receiving a control instruction from a headset display device and converting the control instruction received into a flight action instruction;

executing a corresponding flight action according to the flight action instruction converted;

collecting a flight image and/or a flight parameter during a flight process; and

sending the flight image and/or the flight parameter collected to the headset display device.

Thus, in the preferred embodiment, disposing the collecting module in the headset display device, by wearing the headset display device, the controller is capable of capturing gesture detail image in a field of view below a head of the controller in a FPV (First Person View) mode clearly and comprehensively at a close range. Based on the accurate gesture image collected thereby, the processing module is capable of translating the gesture image into an accurate control instruction precisely and in time, so as to meet the high accuracy and timeliness requirements of the UAV.

In addition, the operator is capable of viewing flight stereoscopic images on the display module through the optical assistant module, so as to directly feel actual flight situation of the UAV by the flight stereoscopic images, in such a manner that the operation is more realistic and operations of the UAV is more convenient. Directly and remotely controlling the UAV by gestures of the operators is capable of further improving control accuracy and decreasing control time.

### BRIEF DESCRIPTION OF THE DRAWINGS

In order to illustrate the technical solution in the preferred embodiment of the present invention more clearly, the accompanying drawings applied in the preferred embodiment of the present invention are briefly introduced as follows. Apparently, the accompanying drawings described below are merely examples of the preferred embodiments of the present invention. One skilled in the art may also obtain other drawings based on these accompanying drawings without creative efforts.

FIG. 1 is a sketch view of a functional module framework of a headset display device according to a first preferred embodiment of the present invention.

FIG. 2 is a structural sketch view of the headset display device according to the first preferred embodiment of the present invention.

FIG. 3 is a sketch view of a functional module framework of an unmanned aerial vehicle (UAV) according to the first preferred embodiment of the present invention.

FIG. 4 is a structural sketch view of the UAV according to the first preferred embodiment of the present invention.

FIG. 5 is a structural sketch view of a flight system according to the first preferred embodiment of the present invention.

FIG. 6 is a flow chart of a method for controlling the UAV according to the first preferred embodiment of the present invention.

FIG. 7 is a flow chart of a method for controlling the UAV according to a second preferred embodiment of the present invention.

### DETAILED DESCRIPTION OF THE PREFERRED EMBODIMENT

In order to make the objectives, technical solutions and advantages of the preferred embodiments of the present invention more comprehensible, the technical solutions in the embodiments of the present invention are clearly and completely described combining with the accompanying drawings in the preferred embodiments of the present invention. Apparently, the preferred embodiments are only a part but not all of the embodiments of the present invention. All other embodiments obtained by people skilled in the art based on the preferred embodiments of the present invention without creative efforts shall fall within the protection scope of the present invention.

It is worth mentioning that in the case of no conflict, the preferred embodiments in the present invention and the characteristics in the preferred embodiments may be combined with each other. The present application will be illustrated in detail below with reference to the accompanying drawings and the preferred embodiments.

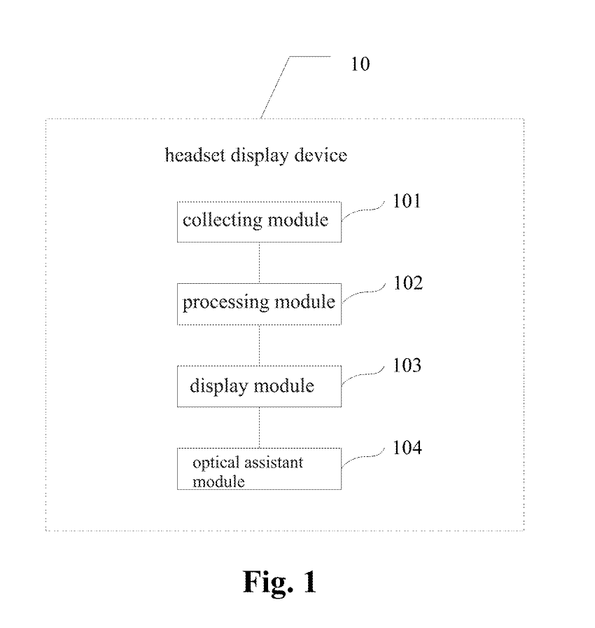

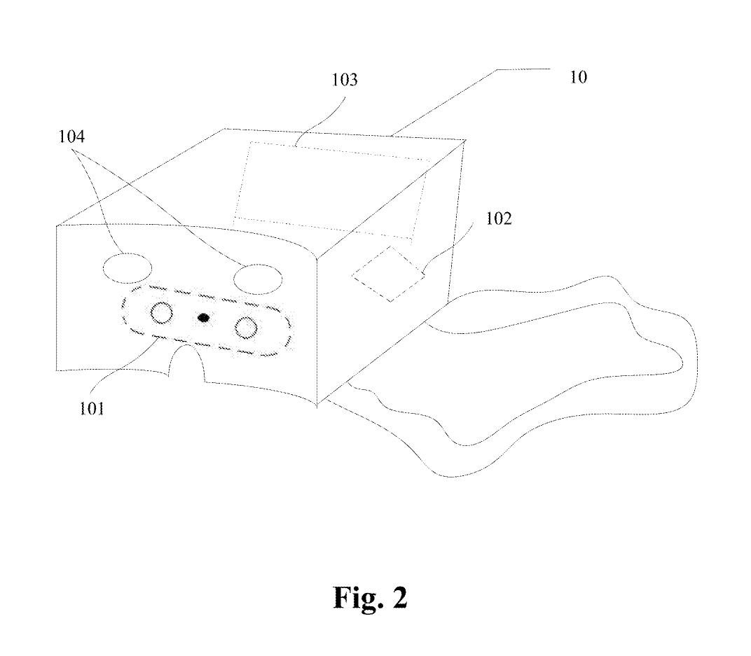

FIG. 1 is a sketch view of a functional module framework of a headset display device according to a first preferred embodiment of the present invention. FIG. 2 is a structural sketch view of the headset display device according to the first preferred embodiment of the present invention.

Referring to FIGS. 1 and 2, a headset display device 10 comprises: a collecting module 101, a processing module 102, a display module 103 and an optical assistant module 104;

wherein the collecting module 101 is configured to collect gesture image information; the processing module 102 is configured to analytically process the gesture image information collected and to translate the gesture image information into a control instruction and for controlling an unmanned aerial vehicle; and to send the control instruction to the unmanned aerial vehicle (UAV);

the display module 103 is configured to receive a flight image and/or flight parameters returned by the UAV and display the flight image and/or the flight parameters on a display interface;

the optical assistant module 104 is configured to perform a left-right split screen on the flight image, in such a manner that a left eye and a right eye of a gesture operator feel seeing a fused stereoscopic image while respectively watching an image displayed on a left screen and an image displayed on a right screen at the same time.

In the preferred embodiment, the headset display device 10 can be applied in a UAV, so as to control flight of the UAV by interacting with the UAV.

In the preferred embodiment, the collecting module 101 is disposed on the headset display device 10, in such a manner that while wearing the headset display device 10, the controller is capable of capturing gesture detail image in a field of view below a head of the controller in a FPV mode clearly and comprehensively at a close range. The gesture image information may be, for example, an image with a finger pointing to left, an image with the finger pointing to right, an image with the finger pointing to a top, an image with the finger pointing to a bottom, and the like. Specifically, gestures can be customized according to actual situations. In general, the higher is the gestural complexity, the greater is the difficulty of identification and the longer is the recognition time.

In the preferred embodiment, FPV is a new game of a screen-watching control model on a ground, which is based on a remote control aviation model or a vehicle model equipped with wireless camera return equipment.

In the preferred embodiment, the flight parameters may be electric quantity parameters, flight altitude parameters, flight velocity parameters, flight direction parameters, GPS (Global Positioning System) position parameters and etc.

In the preferred embodiment, the flight image may be an image shot by the UAV during flight, for example, an image captured by a binocular camera on the UAV.

In the preferred embodiment, the optical assistant module 104 may be a polarizer. The fused stereoscopic image may be a 3D (three-dimensional) image.

The term “and/or” in the present invention is merely an association that describes associated objects, indicating that there may be three relationships, for example, A and/or B, which may mean three cases that: A exists alone; A and B exist together; and B exists alone.

It is worth mentioning that, functional units or functional modules shown in the embodiments may be implemented by hardware, software, firmware, or a combination thereby. When implemented as the hardware, it may for example be an electronic circuit, an application specific integrated circuit (ASIC), a suitable firmware, a plug-in, a function card and etc. When implemented as the software, elements of the present invention are programs or code segments utilized to perform required tasks. The program or code segments may be stored in a machine-readable medium or transmitted over a transmission medium or communication link through data signals carried in a carrier wave. The machine-readable medium may include any medium capable of storing or transmitting information. Examples of the machine-readable media include electronic circuits, semiconductor memory devices, ROMs, flash memory, erasable ROM (EROM), floppy disks, CD-ROMs, optical disks, hard disks, fiber optic media, radio frequency (RF) links, and etc. The code segments can be downloaded via a computer network, such as the internet, an intranet and etc.

Thus, in the preferred embodiment, disposing the collecting module in the headset display device, by wearing the headset display device 10, the controller is capable of capturing gesture detail image in a field of view below a head of the controller in a FPV mode clearly and comprehensively at a close range. Based on the accurate gesture image collected thereby, the processing module is capable of translating the gesture image into an accurate control instruction precisely and in time, so as to meet the high accuracy and timeliness requirements of the UAV.

In addition, the operator is capable of viewing flight stereoscopic images on the display module through the optical assistant module, so as to directly feel actual flight situation of the UAV by the flight stereoscopic images, in such a manner that the operation is more realistic and operations of the UAV is more convenient. Directly and remotely controlling the UAV by gestures of the operators is capable of further improving control accuracy and decreasing control time.

In some embodiments, the collecting module comprises: a binocular imaging unit and an image transmission unit; wherein the binocular imaging unit is configured to simultaneously capture the gesture image information from two different angles and convert the gesture image information captured into digital image information; the image transmission unit is configured to transmit the digital image information to the processing module. Thus, by simultaneously capturing the gesture image information from two different angles, the operator is capable of capturing a gesture detail image in the field of view below the head of the operator in the FPV mode at the close range clearly and comprehensively.

In some embodiments, the binocular imaging unit may comprise a binocular camera, optical filters, and an infrared light source; wherein the optical filters are mounted on lenses of the binocular camera, and the infrared light source is provided on a middle portion of the binocular camera. By the design, gesture images can be obtained from two angles, and filtering is capable of enhancing sharpness and stereoscopic sensation of the gesture image shot thereby.

In some embodiments, the processing module 102 may comprise: a transmission unit, an analysis unit, a conversion unit, a sending unit, and a display unit; wherein the receiving unit is configured to receive the gesture image information; the analysis unit is configured to analyze the gesture image information and recognize meaning of the gesture image information; and the conversion unit is configured to convert recognized meaning of the gesture information into a control instruction for controlling the UAV; the sending unit is further configured to send the control instruction to the UAV and receive the flight image and/or the flight parameters returned by the UAV; the display unit is configured to display the flight image and/or the flight parameters on the display interface.

In some embodiments, the optical assistant module 104 comprises two pieces of optical lenses; wherein the two optical lenses are configured to perform a left-right split screen on the flight image; wherein the two optical lenses may be polarizers.

The functional units in various embodiments of the present invention may be integrated into one processing unit, or may exists as individual physical units, or two or more units integrated into one unit; wherein the integrated unit mentioned above can be implemented in forms of a hardware or a software functional unit.

The embodiments mentioned above realize that in the FPV mode, the operator directly controls the UAV precisely by the gesture, the operation is more realistic, and the operation simplicity of the UAV is increased.

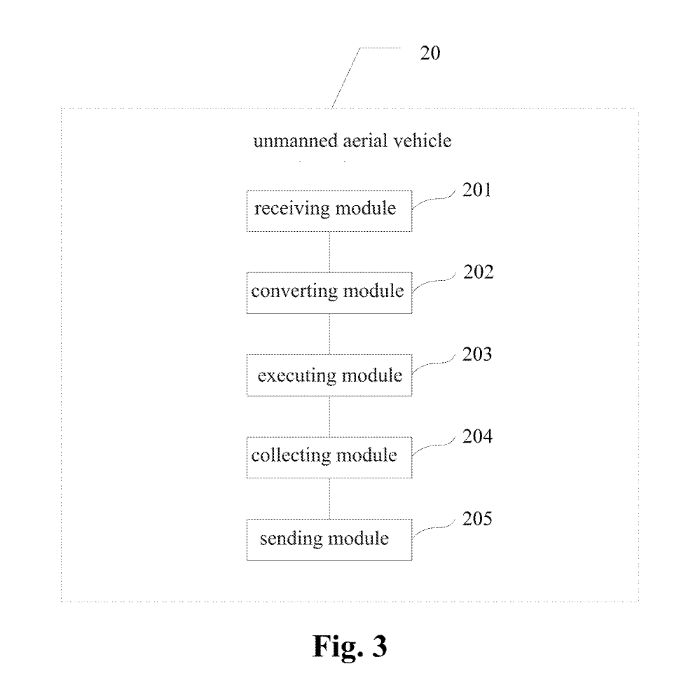

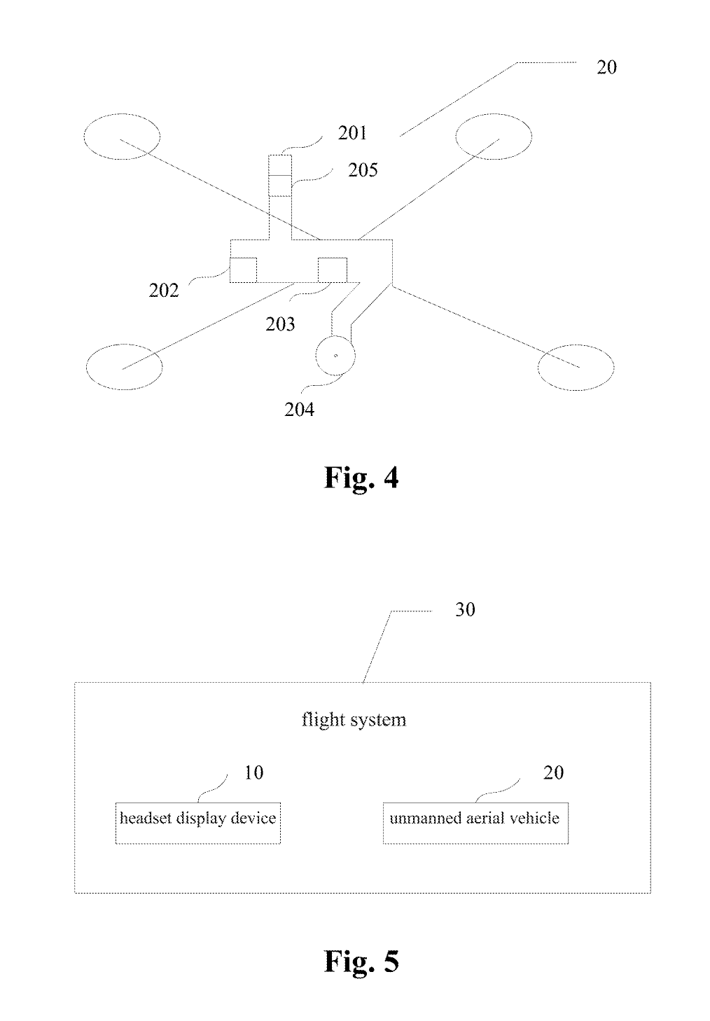

FIG. 3 is a sketch view of a functional module framework of an unmanned aerial vehicle (UAV) according to the first preferred embodiment of the present invention. FIG. 4 is a structural sketch view of the UAV according to the first preferred embodiment of the present invention.

Referring to FIGS. 3 and 4, the unmanned aerial vehicle 20 (UAV) comprises: a receiving module 201, a converting module 202, an executing module 203, a collecting module 204, and a transmitting module 205; wherein the receiving module 201 is configured to receive the control instruction sent by the headset display device 10 in the embodiment shown in FIG. 1 for controlling the UAV 20; the converting module 202 is configured to convert the control instruction received into a flight action instruction; the executing module 203 is configured to execute corresponding flight actions based on the flight action instruction; the collecting module 204 is configured to collect data information during flight; the transmitting module 205 is configured to send the data information collected to the headset display device 10.

In some embodiments, the information collecting module 204 comprises: an image collecting unit and a sensing unit; wherein the image collecting unit is configured to collect the flight image; the sensing unit is configured to collect flight parameters. In some embodiments, the flight parameters comprise at least one of: a power parameter, a flight altitude parameter, a flight velocity parameter, a flight direction parameter and a GPS position parameter. The sensing unit corresponding to the flight parameters may be, for example, a GPS positioning unit, a velocity measuring unit and etc.

People of ordinary skill in the art may be aware that the elements of each example described in conjunction with the preferred embodiments disclosed herein can be implemented in electronic hardware, computer software or a combination of both. In order to clearly illustrate the interchangeability of the hardware and software, the composition of each example has been generally described according to function in the above description. Whether these functions are implemented by hardware or software depends on the specific application and constraints designed of the technical solutions. One skilled in the art can utilize various methods on each particular application to implement the described functions, such implementation should not be considered as beyond the scope of the present invention.

In several embodiments provided by the present application, it should be noted that the system, apparatus, and method disclosed therein can be implemented in other manners. For example, the device embodiments described above are merely exemplary. For example, the unit division is merely logical function division and other division manner exists in actual implementation. For example, multiple units or components can be combined or integrated into another system, or some features can be ignored or not executed. In addition, the mutual coupling or direct coupling or communication connection shown or discussed therebetween may be indirect coupling or communication connection through some interfaces (such as a USB interface), devices or units, or may be electrical or mechanical connection, or connections in other forms.

FIG. 5 is a structural sketch view of a flight system according to the first preferred embodiment of the present invention.

As shown in FIG. 5, the flight system comprises: a headset display device 10, and an unmanned aerial vehicle (UAV); wherein the headset display device 10 can be embodied as the device 10 in the FIG. 1. The UAV 20 can be embodied as the UAV 20 in the embodiments shown in FIG. 2.

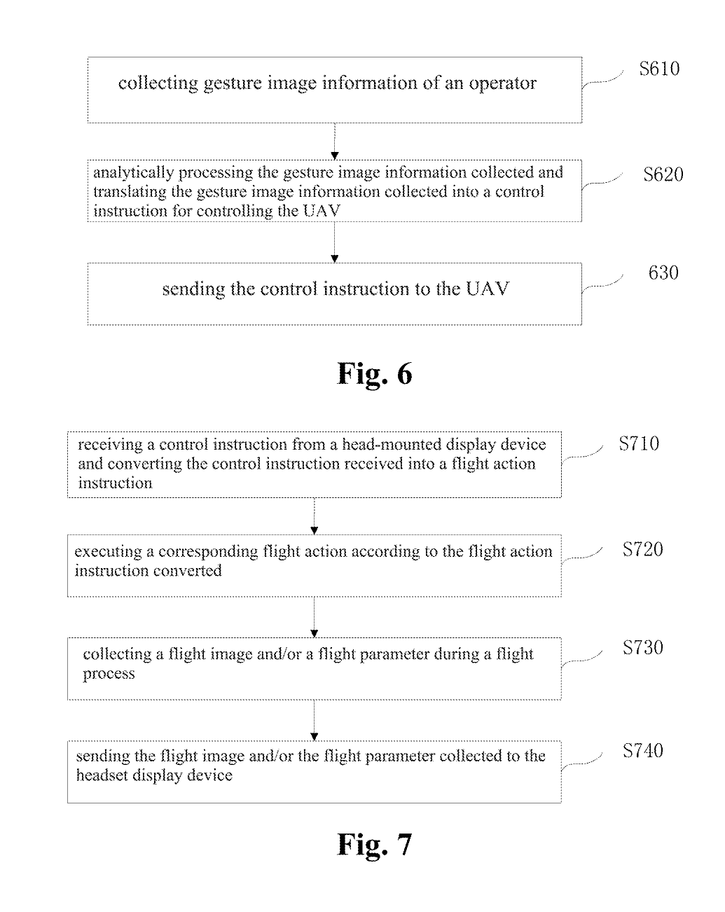

FIG. 6 is a flow chart of a method for controlling the UAV according to the first preferred embodiment of the present invention.

The embodiment can be applied in the headset display device. As shown in FIG. 6, a method comprises following steps of: S610: collecting gesture image information of an operator; S620: analytic processing the gesture image information collected and translating the gesture image information collected into a control instruction for controlling the UAV; S630: sending the control instruction to the UAV.

As a variation of the embodiment shown in FIG. 6, the following steps may be added to the embodiment shown in FIG. 6: receiving flight images and/or flight parameters from the UAV and displaying on a display interface.

In some embodiments, the flight parameters comprise at least one of: a power parameter, a flight altitude parameter, a flight velocity parameter, a flight direction parameter and a GPS position parameter.

FIG. 7 is a flow chart of a method for controlling the UAV according to a second preferred embodiment of the present invention. The embodiment can be applied in the UAV. As shown in FIG. 7, the method comprises following steps of: S710: receiving the control instruction from the headset display device and converting the control instruction received into a flight action instruction; S720: executing a corresponding flight action according to the flight action instruction converted; S730: collecting a flight image and/or flight parameters during a flight process; and S740: sending the flight images and/or flight parameters collected to the headset display device.

It is worth mentioning that the operations described in FIGS. 7 and 8 may be utilized in different combinations. For conciseness, the implementation of various combinations is not described here in detail. One skilled in the art may flexibly regulate orders of the steps mentioned above according to requirements, or flexibly combine operations of the steps mentioned above and etc.

In addition, the device or system in each embodiment mentioned above can serve as an executing subject in the method in each of the foregoing embodiments, so as to implement corresponding processes in each process. The contents in the foregoing embodiments may be utilized for reference. For conciseness, details are not illustrated here again.

The device embodiments mentioned above are merely exemplary. The units described as separate components may or may not be physically separated. The components displayed as units may or may not be physical units, i.e, may be located in one place, or be distributed on multiple network elements. Some or all of the modules may be selected according to actual needs to achieve the objectives of the solutions in the embodiment. One skilled in the art can understand and implement without creative work.

Based on the embodiments mentioned above, those skilled in the art can clearly understand that the embodiments can be implemented by a software plus a necessary universal hardware platform, and certainly may also be implemented by hardware. Based on this understanding, the essence of technical solutions mentioned above, or their contribution to the conventional arts, may be embodied in the form of a software product, which may be stored in a computer readable storage medium such as a ROM/RAM, a magnetic disc, an optical disc and etc, including a plurality of instructions for make a computer device, such as a personal computer, a server, or a network device, etc. to execute the processes described in each embodiment or some of the embodiments.

Finally, it is worth mentioning that the embodiments mentioned above are merely intended for describing the technical solutions of the present invention, but not for limiting the present invention. Although the present invention is described in detail with reference to the embodiments mentioned above, it should be understood by those skilled in the art that: modifications can be made to the technical solutions described in the embodiments mentioned or equivalent replacements are partially made to the technical features. These modifications or replacements do not make the essence of the corresponding technical solutions depart from the spirit and scope of the technical solutions in the embodiments of the present invention.

What is claimed is:

1. A headset display device for an unmanned aerial vehicle (UAV), comprising:
a collecting module configured to collecting gesture image information;
a processing module configured to analytically process the gesture image information collected and translate the gesture image information collected into a control instruction for controlling the UAV; and send the control instruction to the UAV;
a display module configured to receive a flight image and/or a flight parameter returned by the UAV and display the flight image and/or the flight parameter on a display interface; and
an optical assistant module configured to perform a left-right split screen on the flight image, in such a manner that a left eye and a right eye of a gesture operator feel seeing a fused stereoscopic image while respectively watching an image displayed on a left screen and an image displayed on a right screen at the same time.

2. The headset display device, as recited in claim 1, wherein the collecting module comprises:
a binocular imaging unit configured to simultaneously capture the gesture image information from two different angles and convert the gesture image information captured into digital image information; and
an image transmission unit configured to transmit the digital image information to the processing module.

3. The headset display device, as recited in claim 2, wherein the binocular imaging unit comprises:
a binocular camera;
optical filters; and
an infrared light source;
wherein the optical filters are mounted on lenses of the binocular camera, and the infrared light source is provided on a middle portion of the binocular camera.

4. The headset display device, as recited in claim 1, wherein the processing module comprises:
a receiving unit configured to receive the gesture image information;
an analysis unit configured to analyze the gesture image information and recognize meaning of the gesture image information;
a conversion unit configured to convert the meaning recognized of the gesture information into the control instruction for controlling the UAV;
a sending unit further configured to send the control instruction to the UAV and receive the flight image and/or the flight parameter returned by the UAV; and
a display unit configured to display the flight image and/or the flight parameter on the display interface.

5. The headset display device, as recited in claim 1, wherein the optical assistant module comprises: two pieces of optical lenses configured to perform a left-right split screen on the flight image.

6. An unmanned aerial vehicle (UAV), comprising:
a receiving module configured to receive the control instruction sent by the headset display device as recited in claim 1 for controlling the UAV;
a converting module configured to convert the control instruction received into a flight action instruction;
an executing module configured to execute corresponding flight actions based on the flight action instruction;
a collecting module configured to collect data information during flight; and
a transmitting module configured to send the data information collected to the headset display device.

7. The UAV, as recited in claim 6, wherein the collecting module comprises:
an image collecting unit configured to collect a flight image; and
a sensing unit configured to collect a flight parameter.

8. The UAV, as recited in claim 7, wherein the flight parameter is at least one member selected from the group consisting of: a power parameter, a flight altitude parameter, a flight velocity parameter, a flight direction parameter and a GPS (Global Positioning System) position parameter

9. An unmanned aerial vehicle (UAV) controlling method for a side with a headset display device, comprising steps of:
collecting gesture image information of an operator;
analytically processing the gesture image information collected and translating the gesture image information collected into a control instruction for controlling the UAV;
sending the control instruction to the UAV.

10. The method, as recited in claim 9, further comprising a step of: receiving a flight image and/or a flight parameter from the UAV and displaying on a display interface.

11. The method, as recited in claim 10, wherein the flight parameter is at least one member selected from the group consisting of: a power parameter, a flight altitude parameter, a flight velocity parameter, a flight direction parameter and a GPS (Global Positioning System) position parameter.
